(19) United States
(12) Patent Application Publication
(10) Pub. No.: US 2026/0242149 A1
(43) Pub. Date: Aug. 20, 2026

(54) WEAR ASSEMBLY FOR A HELICALLY FORMED, METAL DECANTER SCREW CONVEYOR

(71) Applicant: Alfa Laval Corporate AB, LUND (SE)

(72) Inventor: Egon TANDRUP, SLANGERUP (DK)

(73) Assignee: Alfa Laval Corporate AB, LUND (SE)

(21) Appl. No.: 18/878,981

(22) PCT Filed: Jul. 4, 2023
(86) PCT No.: PCT/EP2023/068298

§ 371 Date: Dec. 26, 2024

(30) Foreign Application Priority Data
Jul. 20, 2022 (EP) 22186024.0

(51) Int. Cl. B65G 33/26; B04B 3/04

(52) U.S. Cl. CPC B65G 33/26; B04B 3/04; B65G 2207/48

(57) ABSTRACT

A wear assembly for a helically formed, metal screw conveyor of a decanter centrifuge includes a wear plate defining wear plate connection surfaces extending substantially in the longitudinal direction on the wear plate rear surface and a wear plate abutment surface extending substantially parallel with the wear plate top edge. The assembly further includes a backing plate defining backing plate connection surfaces on the backing plate front surface for engaging with the wear plate connection surfaces. The backing plate further defining a backing plate abutment surface on the backing plate front surface for contacting the wear plate abutment surface when the backing plate connection surfaces have been engaged with the wear plate connection surfaces.

The present invention relates to a wear assembly for a helically formed, metal screw conveyor of a decanter centrifuge, a helically formed, metal screw conveyor for a decanter centrifuge and a method of installing a wear assembly on a helically formed, metal screw conveyor for a decanter centrifuge.

### INTRODUCTION

Decanter centrifuges are used in a variety of applications for separating a feed consisting of a solid-liquid mixture into light phase (liquids) and heavy phase (solids) components. Decanter centrifuges include a rotatable bowl and a helically formed, metal screw conveyor rotatable on a common axis. The feed is typically injected at the centre of the decanter centrifuge and separated into the heavy phase and the light phase which are ejected at opposite large and conical ends of the bowl, respectively. The light phase is accumulated near the axis and ejected at the large end whereas the heavy phase is accumulating at the inner surface of the bowl wall and conveyed to an outlet at the conical end by the helically formed, metal screw conveyor rotating at a speed slightly different from the rotational speed of the bowl.

When the heavy phase is corrosive, there is a need for making the screw conveyor abrasion resistant to prolong the lifetime of the screw conveyor. Corrosive feeds are found in e.g. the mining industry (e.g. rocks), oil industry (e.g. sand) and food industry (e.g. stones). The conveyor can be made abrasion resistant by providing a wear plate of abrasion resistant material on the edge of the screw conveyor. Due to the corrosive nature of the feed, laser cladding or brazing of the wear plate is not preferred. It is preferred to have a pure mechanical attachment of the wear plate onto a backing plate forming an assembly. The assembly can then be attached to the edge of the screw conveyor by fastening the backing plate to the edge of the screw conveyor by welding, brazing or similar fastening technologies.

CN204249388 describes a centrifugal decanter having a ceramic element connected to a support body by means of a dovetail connection.

U.S. Pat. No. 8,523,751 describes a screw centrifuge comprising a series of thin ceramic plates which are fixed next to one another at the outer edge of the screw. The plate have at least two formed ceramic protrusions protruding from the thin ceramic plates and are arranged in recesses which are profiled according to the protrusions.

GB2130508 describes a screw centrifuge with a wear-resistant plate having a resilient rubber between the wear plate and support plate. It may also have a pin-shaped extension.

U.S. Pat. No. 5,429,581 describes a centrifugal decanter having a wear resistant member with a dovetail projection having a threaded bore.

U.S. Pat. No. 6,230,960 describes a centrifuge with a tile having a dovetail. A tile carrier includes a dovetail slot or groove defined between mutually facing, upper and lower lips adapted, in use, to be engaged by lips of the tile.

KR1020170013456 describes comprises a tile body and a tile tip having a fixating protrusion and a fixating hole on oneside, respectively. The fixating protrusion and the fixating hole are combined to each other.

US 2006/0046081 describes a multi-layer laminated wear-resistant assembly comprising a bracket layered between a plate of wear-resistant material. The layers of the assembly are secured together by soldering, brazing or some other method. The bracket material is trapped and stays stretched between the two layers of harder materials.

WO2014/183772 describes a centrifugal decanter with a tile dovetail locking. The support plate has an opening into which the wear tile is inserted. The opening forms an upper corner allowing a male corner of the wear tile to be inserted.

GB2048728 and U.S. Pat. No. 4,328,925 both describe a centrifugal decanter having an abrasion resistant member with mating surfaces mechanically connecting the abrasion resistant member to a backing plate. The mating surfaces prevent radial outward movement of the abrasion resistant member.

WO9413403 describe a centrifugal decanter with wear resistant members mounted along the edge of the scew conveyor. The members have dove tail projections on their rear surfaces. The projections taper in width in the radial direcion. The members can be engared directly with its respective backing plate by sliding movement substantially radiual to the axis of the screw.

GB2273253B relates to a conveyor screw having backing plates and tiles engaged to the backing plates by radia sliding movement. Each tile is retained radially inward movement solely by the abutment with adjacent tiles.

Having mating surfaces mechanically connecting the wear resistant member to a backing plate and preventing radial outward movement of the abrasion resistant member may cause the abrasion resistant member to become loose if the wear resistant plate is worn down to the mating surfaces. In that case the wear resistant member may be thrown towards the inner surface of the bowl wall, possibly causing significant damage to the bowl wall.

Having a dove tail projection taper in width in the radial direcion may keep the wear resistant plate in place even when the abrasion resistant member wears down. However, as the tapering projection is directed in the radial direction towards the bowl wall, the tapering projection is sensitive to manufacturing tolerances. A minor deviation in the measurements of the tapering projection may cause a large deviation of the wear plate in the radial direction. The wear plate may thus extend too far in the radial direction and possibly cause damage to the inner wall of the bowl.

It is thus an object of the present invention to provide technologies for avoiding the above-mentioned drawbacks of the prior art.

### SUMMARY OF THE INVENTION

The above object is in a first aspect realized by a wear assembly for a helically formed, metal screw conveyor of a decanter centrifuge, the assembly comprising:
a wear plate defining a wear plate front surface and a wear plate rear surface, the wear plate rear surface defining a wear plate top edge, a wear plate bottom edge and two oppositely located wear plate side edges interconnecting the wear plate top edge and the wear plate bottom edge, the wear plate rear surface further defining a longitudinal direction extending from the bottom edge to the top edge, the wear plate defining wear plate connection surfaces extending substantially in the longitudinal direction on the wear plate rear surface and a wear plate abutment surface extending substantially parallel with the wear plate top edge on the wear plate rear surface, and
a backing plate defining a backing plate front surface and a backing plate rear surface, the backing plate rear surface being attachable to the helically formed, metal screw conveyor, the backing plate defining backing plate connection surfaces on the backing plate front surface for engaging with the wear plate connection surfaces, the backing plate further defining a backing plate abutment surface on the backing plate front surface for contacting the wear plate abutment surface when the backing plate connection surfaces have been engaged with the wear plate connection surfaces.

The wear assemblies are attached side-by-side on the edge of the helically formed, metal screw conveyor of a decanter centrifuge. The wear plate has connection surfaces extending substantially in the longitudinal direction. The wear plate connection surfaces mainly face the wear plate side edges. When the backing plate front surface engages with the wear plate connection surfaces, the wear plate connection surfaces is facing and engaging the backing plate connection surfaces for holding the wear plate rear surface against movement in a direction away from the backing plate front surface, i.e. preventing separation between the wear plate and the backing plate. The wear plate connection surfaces and the backing plate connection surfaces should be suitably formed to prevent such separation when the wear plate connection surfaces and the backing plate connection surfaces are engaged. The wear plate connection surfaces are facing and engaging the backing plate connection surfaces also for holding the wear plate against side-to-side movement, i.e. in a direction between the side edges.

When the backing plate connection surfaces have engaged with the wear plate connection surfaces, the backing plate abutment surface will contact the wear plate abutment surface for retaining the wear plate relative to the backing plate in the longitudinal direction. As the wear plate abutment surface is extending substantially parallel with the wear plate top edge, the wear plate abutment surface provides a well-defined stop for the wear plate relative to the backing plate, preventing the top edge from reaching too far towards the inner wall of the bowl. The distance between the top edge of the wear plate and the inner wall of the bowl can thus be determined and controlled very accurately. A small manufacturing error on the plate will only have a small effect on the distance between the top edge and the inner wall of the bowl. In comparison, if the distance between the top edge of the wear plate and the inner wall of the bowl is being determined by the contact between tapering wear plate connection surfaces and the backing plate connection surfaces which are extending substantially in the longitudinal direction, a small manufacturing error on the plate will have a large effect on the distance between the top edge and the inner wall of the bowl.

The backing plate abutment surface is preferably complementary to the wear plate abutment surface such that the backing plate abutment surface is contacts the wear plate abutment surface along a contact line being substantially parallel with the wear plate top edge. The wear plate abutment surface is preferably located adjacent the top edge, however, it can also be located adjacent to the lower edge.

According to a further embodiment of the first aspect, the backing plate connection surfaces engages with the wear plate connection surfaces by a sliding movement between the wear plate rear surface and the backing plate front surface in the longitudinal direction of the wear plate.

The sliding movement allows the wear plate connection surfaces and the backing plate connection surfaces to be engaged in an easy and secure way and allow the wear plate abutment surface to contact the backing plate abutment surface.

According to a further embodiment of the first aspect, the backing plate connection surfaces and the wear plate connection surfaces define a projection and a slot of complementary shape in which the projection engages.

A projection which is engaging a slot holds the wear plate rear surface against movement in a direction away from the backing plate front surface, i.e. preventing separation between the wear plate and the backing plate.

According to a further embodiment of the first aspect, the projection is provided on the wear plate and the slot is formed in the backing plate.

The wear plate is thereby supported by the backing plate, which is beneficial as the wear plate is typically more brittle than the backing plate.

According to a further embodiment of the first aspect, the projection has a dovetail cross-section.

A dovetail cross section of the projection will hold the wear plate rear surface against movement in a direction away from the backing plate front surface, i.e. preventing separation between the wear plate and the backing plate

According to a further embodiment of the first aspect, the projection and the slot taper in width in the longitudinal direction.

In this way the wear plate will be limited in the longitudinal direction even if the wear plate abutment surface and the backing plate abutment surface have been worn off. This allows the wear plate abutment surface to be located close to the top edge of the wear plate. When the wear plate abutment surface has been worn off, the movement of the wear plate relative to the backing plate in the longitudinal direction will be limited by the contacting of the wear plate connection surfaces with the backing plate connection surfaces. This will prevent the wear plate from becoming loose and being thrown towards the inner surface of the bowl wall, even if the wear plate abutment surface and the backing plate abutment surface have been worn off. When the abutment surfaces wear off, there will be a small movement of the wear plate relative to the backing plate in the longitudinal direction as the wear plate connection surfaces comes into contact with the backing plate connection surfaces.

According to a further embodiment of the first aspect, the assembly further comprising a locking plate which, when the wear plate engages the backing plate is being attachable to the backing plate at the wear plate bottom edge for retaining the wear plate relative to the backing plate in a direction from the wear plate top edge towards the wear plate bottom edge.

To hold the wear plate relative to the backing plate in a direction opposite to the longitudinal direction, a locking plate may be used. The wear plate will be located between the locking plate and the inner wall of the bowl and thus not come into significant contact with the solid part of the feed, thus it will not be worn down significantly. Preferably, the locking plate is keeping a pressure onto the wear plate bottom edge in the longitudinal direction to ensure that the wear plate abutment surface contacts the backing plate abutment surface. The locking plate can be spot welded to the backing plate.

According to a further embodiment of the first aspect, the locking plate comprising a protrusion which, when the wear plate engages the backing plate, protrudes into a complementary slot in the wear plate.

The protrusion and the complementary slot may be used to ensure that the wear plate is locked in a centered position relative to the backing plate and/or prevent any movement from side to side.

According to a further embodiment of the first aspect, a rubber film is provided between the wear plate and the backing plate, the rubber film preferably being applied on the wear plate rear surface and/or the backing plate front surface by spraying.

Having a rubber film between the wear plate and the backing plate may provide some elasticity in the assembly which may avoid cracking of the wear plate.

According to a further embodiment of the first aspect, the backing plate comprises a wear indicator on the rear surface.

The wear indicator may be in the form of markings or ribs which are worn off and thus indicates when to replace the wear assembly

According to a further embodiment of the first aspect, the top edge is between 10 mm to 100 mm, preferably between 25 mm to 75 mm.

The wear assembly should preferably have the above measurements to be able to fit in typical decanter centrifuges.

According to a further embodiment of the first aspect, the backing plate being made of a softer material than the wear plate, the wear plate preferably being made of carbide such as tungsten carbide, ceramic, polyurethan or polyurea, and the backing plate preferably being made of steel, such as stainless steel.

The wear plate may be made of a harder material than the backing plate for resisting abrasion. The backing plate may be made of a softer material to be attachable to the edge of the helically formed, metal screw conveyor by welding, brazing or similar. The above materials are suitable as wear plate and backing plate, respectively.

The above object is in a second aspect realized by a helically formed, metal screw conveyor for a decanter centrifuge comprising one or more wear assemblies according to any of the embodiments of the first aspect, wherein the backing plate rear surface being attached to an edge of the helically formed, metal screw conveyor and the longitudinal direction corresponds to a radially outward direction from an axis of the helically formed, metal screw conveyor.

The wear assembly is first mechanically assembled and then attached at the top edge of the helically formed, metal screw conveyor. The backing plate is fastened to the helically formed, metal screw conveyor whereas the wear plate should be facing in the outward direction on the helically formed, metal screw conveyor, relative to the rotational axis. Typically, several wear assemblies are assembled and attached along the edge of the helically formed, metal screw conveyor.

According to a further embodiment of the second aspect, the wear assembly is attached to the helically formed, metal screw conveyor by a weld at the edge of the helically formed, metal screw conveyor.

The backing plate of the assembly is typically attached by a weld at the edge of the metal screw conveyor. An additional weld can be made at the front surface of the helically formed, metal screw conveyor at the intersection between the backing plate and the helically formed, metal screw conveyor opposite the top edge. MMA, TIG or MAG welding can preferably be used.

The above object is in a third aspect realized by a method of installing a wear assembly on a helically formed, metal screw conveyor for a decanter centrifuge, the assembly comprising:
a wear plate defining a wear plate front surface and a wear plate rear surface, the wear plate rear surface defining a wear plate top edge, a wear plate bottom edge and two oppositely located wear plate side edges interconnecting the wear plate top edge and the wear plate bottom edge, the wear plate rear surface further defining a longitudinal direction extending from the bottom edge to the top edge, the wear plate defining wear plate connection surfaces extending substantially in the longitudinal direction on the wear plate rear surface and a wear plate abutment surface extending substantially parallel with the wear plate top edge on the wear plate rear surface, and
a backing plate defining a backing plate front surface and a backing plate rear surface, the backing plate rear surface being attachable to the helically formed, metal screw conveyor, the backing plate defining backing plate connection surfaces on the backing plate front surface, the backing plate further defining a backing plate abutment surface on the backing plate front surface, the method comprising performing the steps of:
engaging the backing plate connection surfaces with the wear plate connection surfaces, and,
contacting the backing plate abutment surface with the wear plate abutment surface.

The method according to the third aspect preferably used a wear plate assembly according to any of the embodiments of the first aspect. For example, the wear plate is preferably engaged to the backing plate by a sliding movement. Further steps may include welding the locking plate to the backing plate. The assembly is subsequently welded to the helically formed, metal screw conveyor.

### BRIEF DESCRIPTION OF THE DRAWINGS

FIG. 1A is a perspective view of a helically formed, metal screw conveyor.

FIG. 1B is a closeup perspective view of a wear assembly.

FIG. 2A is a side view of the wear assembly according to a first embodiment.

FIG. 2B is a perspective view of the mounting procedure of the wear plate.

FIG. 2C is a 2nd perspective view of the mounting procedure of the wear plate.

FIG. 3A shows a side view of the locking procedure of the wear plate.

FIG. 3B shows a perspective view of the locking procedure of the wear plate

FIG. 3C shows a 2nd perspective view of the locking procedure of the wear plate.

FIG. 4A shows a side view of the engaged and locked wear assembly.

FIG. 4B shows a perspective view of the wear assembly engaged and locked.

FIG. 4C shows a 2nd perspective view of the wear assembly engaged and locked.

FIG. 5 shows a third perspective view of the wear assembly in a non-engaged and unlocked state.

FIG. 6 shows a perspective view of an alternative embodiment of the wear assembly.

### DETAILED DESCRIPTION OF THE DRAWINGS

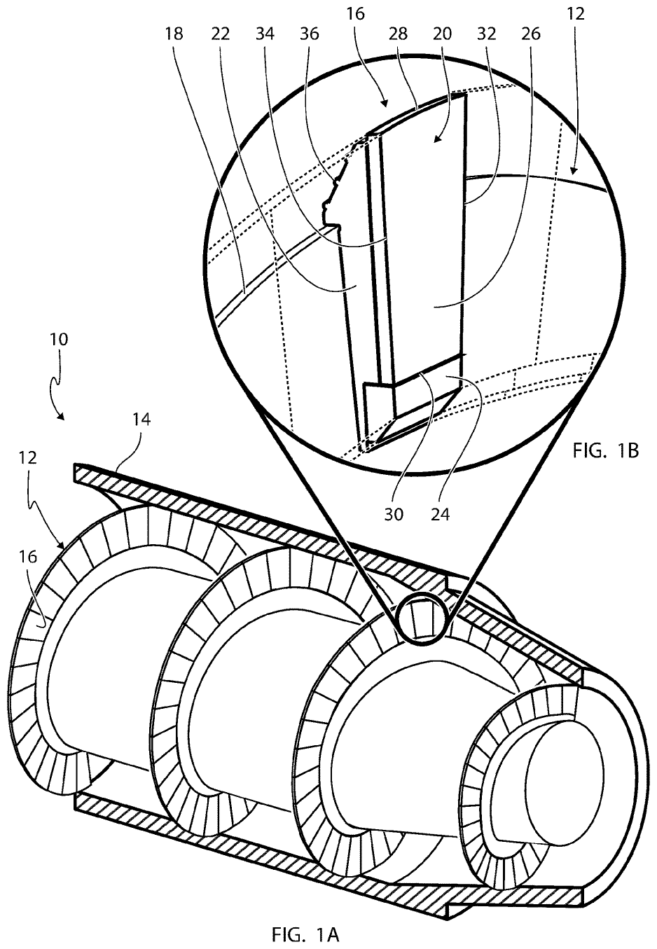

FIG. 1A shows a a decanter centrifuge 10 having a helically formed, metal screw conveyor 12 located within a cylindrical bowl 14 of the decanter centrifuge 10. The position of the wear assembly 16 is shown in the closeup view of FIG. 1B.

The screw conveyor 12 is provided with a plurality of wear assemblies 16 located at the outer edge 18 of the screw conveyor 12. Each wear assembly 16 comprises a wear plate 20, a backing plate 22 and a locking plate 24. The wear assembly 16 is first assembled, then fixated to the outer edge 18 of the screw conveyor 12.

The wear plate 20 comprises a wear plate front surface 26 and an opposite wear plate rear surface (not visible) which is mechanically fixated to a front surface (not visible) of the backing plate 22. The wear plate front surface 26 comprises a top edge 28, a bottom edge 30 and two opposite side edges 32 34 interconnecting the top edge 28 and the bottom edge 30.

The wear plate 20 is mechanically fixated on the backing plate 22 such that the wear plate top edge 28 is located adjacent the bowl wall 14 but avoiding contact with the bowl wall 14. The locking plate 24 is fixated on the backing plate 22 adjacent the bottom edge 30, typically by spot welding. The locking plate 24 keeps the wear plate 20 in place. The wear assembly 16 is then welded to the screw conveyor 12 by a weld (not shown) at the outer edge 18 of the helically formed, metal screw conveyor. An additional weld (not shown) can be made at the front surface of the helically formed, metal screw conveyor 12 at the intersection between the backing plate 22 and the helically formed, metal screw conveyor 12 opposite the outer edge 18. MMA, TIG or MAG welding can preferably be used.

The backing plate 22 further comprises wear indicators 36 which indicates the wear on the wear assembly 16. The wear indicators 22 comprise protrusions which are worn off as an indication of wear as the wear assembly 16 wears down.

The wear plate 20 is made of a wear resistant material such as tungsten carbide, ceramic, polyuretan or polyurea, and the backing plate 22 is made of weldable material such as steel, typically stainless steel. The locking plate 24 is typically made of the same weldable material as the backing plate 22. The wear plate 20 protects the backing plate 22 and the helically formed, metal screw conveyor 12 against excessive wear.

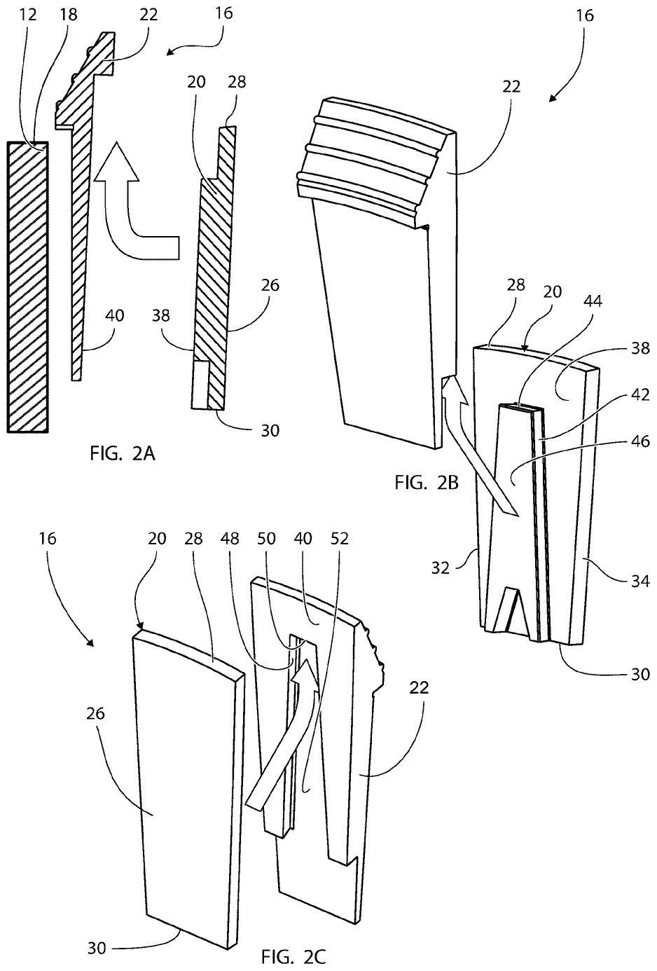

FIG. 2A shows a side view of the wear assembly 16 according to a first embodiment together with the edge 18 of the screw conveyor. The wear plate 20 is engaged to the backing plate 22 as shown by the arrow. The rear surface 38 of the wear plate 20 is mechanically mounted on the front surface 40 of the backing plate 22. The backing plate 22 is welded onto the screw conveyor at the outer edge.

FIG. 2B shows a perspective view of the engaging procedure of the wear plate 20 onto the backing plate 22. The rear surface 38 of the wear plate 20 comprises a projection 46 of the rear surface 38. The projection 46 has a dovetail shape which is tapering towards the wear plate top edge 28. The projection 46 is engaged with a complementary slot (not visible) on the backing plate front surface (not visible) by a sliding motion as shown by the arrow. The projection 46 comprises two opposite wear plate connection surfaces 42 extending along the side edges 32 34 and a wear plate abutment surface 44 extending substantially parallel with the top edge 28 of the wear plate 20.

FIG. 2C shows a second perspective view of the engaging procedure of the wear plate 20 onto the backing plate 22. The backing plate front surface 40 comprises two opposite backing plate connection surfaces 48 extending along the side edges 32 34 and a backing plate abutment surface 50. The front surface 40 of the backing plate 22 comprises a slot 52 which is complementary with the projection (not visible) of the wear plate 20 and in which the projection (not visible) on the wear plate rear surface (not visible) is engaged as show by the arrow. In this way the wear plate 20 engages the backing plate 22.

When the projection (not visible) engages the slot, the wear plate connection surfaces (not visible) faces and engages the backing plate connection surfaces for holding the wear plate rear surface 38 against movement in a direction away from the backing plate front surface 40, i.e. preventing separation between the wear plate 20 and the backing plate 22. This is performed by the dove tail formation of the projection 46 and the complementary shape of the slot 52.

When the backing plate connection surfaces 48 have engaged with the wear plate connection surfaces (not visible), the wear plate abutment surface (not visible) contacts the backing plate abutment surface 50 for retaining the wear plate 20 relative to the backing plate 22 in a longitudinal direction extending from the bottom edge 30 to the top edge 28.

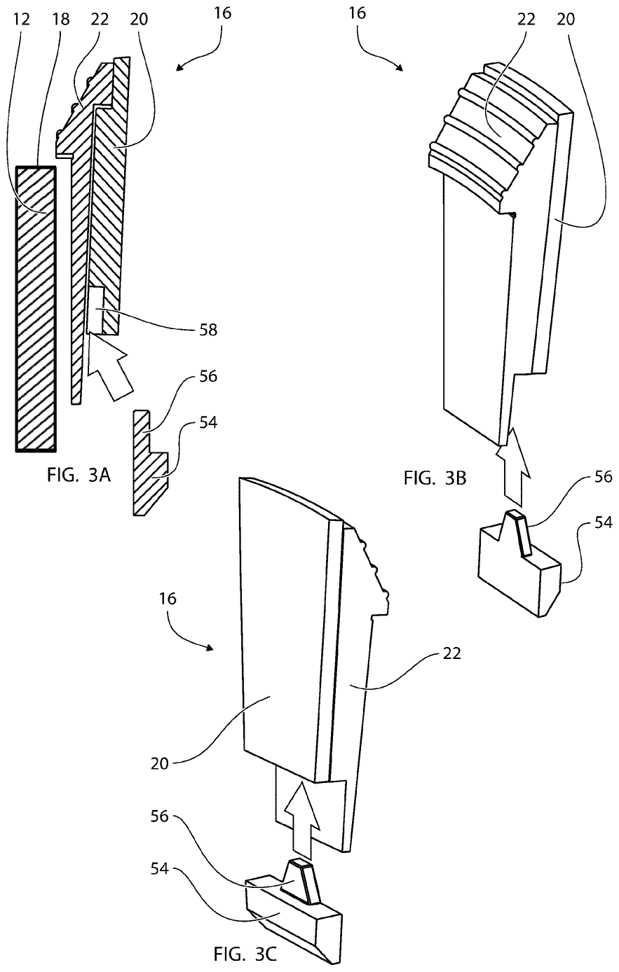

FIG. 3A shows a side view of the locking procedure of the wear plate 20 relative to the backing plate 22 in the opposite longitudinal direction by the use of a locking plate 54. The locking plate 54 comprises a protrusion 56 which is inserted into a complementary opening 58 of the wear plate 20. The locking plate 54 is inserted in the direction as shown by the arrow and may keep a pressure onto the wear plate bottom edge 30 in the opposite longitudinal direction to ensure that the wear plate abutment surface contacts the backing plate abutment surface. The locking plate 54 is then spot welded to the backing plate 22.

FIG. 3B shows a perspective view of the locking procedure of the wear plate 20 relative to the backing plate 22 in the opposite longitudinal direction. The protrusion 56 of the locking plate 54 has a tapered shape which is complementary with the opening (not visible) in the wear plate 20. Thus, the protrusion 56 and the opening 58 helps both to fixate the wear plate 20 in the longitudinal direction and to center the wear plate 20 on the backing plate 22 when inserted as shown by the arrow.

FIG. 3C shows a second perspective view of the locking procedure of the wear plate 20 relative to the backing plate 22, whereby the locking plate 54 is moved as shown by the arrow.

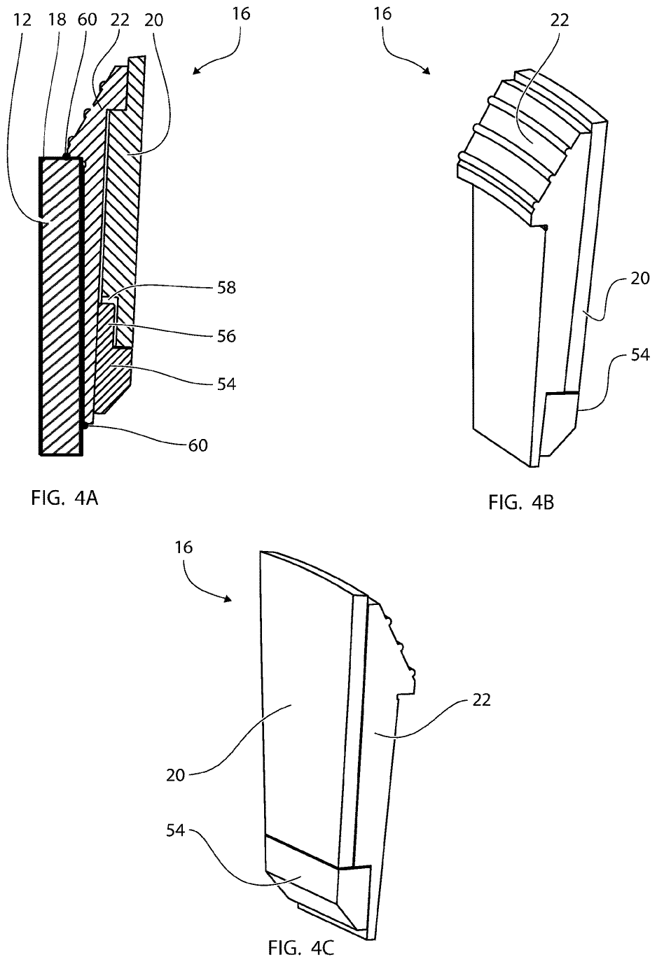

FIG. 4A shows a side view of the engaged and locked wear assembly 16 fixated on the outer edge 18 of the screw conveyor 12. The wear plate 20 is mechanically fixed to the backing plate 22 and locked in place by the locking plate 54. The locking plate 54 typically is spot welded to the backing plate 22. The wear assembly 16 is then welded to the screw conveyor 12 by a weld 60 where the outer edge 18 of the helically formed, metal screw conveyor intersects the backing plate 22 and an additional weld 60 at the front surface of the helically formed, metal screw conveyor 12 at the intersection between the backing plate 22 and the helically formed, metal screw conveyor 12 opposite the outer edge 18. MMA, TIG or MAG welding can preferably be used.

FIG. 4B shows a perspective view of the engaged and locked wear assembly 16 which is ready to be fixated to the edge 18 of the screw conveyor.

FIG. 4C shows a second perspective view of the engaged and locked wear assembly 16 which is ready to be fixed to the edge 18 of the screw conveyor.

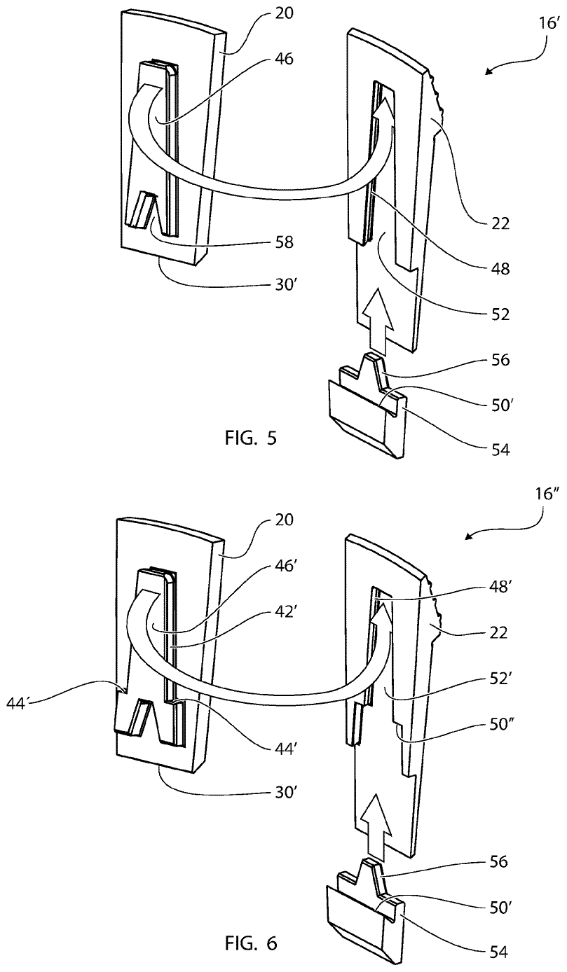

FIG. 5 shows a perspective view of a wear assembly 16′ in a non-engaged and unlocked state. The present locking plate 54 has an sloped edge 50′ which is corresponding to an further sloped edge 30′ of the wear plate 20. The sloped edges contact to ensure an even better mechanical connection between the wear plate 20, the backing plate 22 and the locking plate 54′.

The engaging and locking procedure is the same as the previous embodiment: In the first step shown by the rounded arrow, the backing plate connection surfaces 46 engages with the wear plate connection surfaces 42, and, in the second step shown by the straight arrow, the backing plate abutment surface 50′ contacting with the wear plate abutment surface 44 as the locking plate 54 is attached to the backing plate 22.

FIG. 6 shows a perspective view of an alternative embodiment of the wear assembly 16′ in a non-engaged and unlocked state. In the present embodiment, the projection 46′ has a different shape having a wear plate abutment surface 44′ located closer to the bottom edge 30. The wear plate abutment surface 44′ is still parallel with the top edge 28 but located along the respective wear plate connection surfaces 42′. The corresponding slot 52′ has a corresponding different shape defining the backing plate abutment surface 50′ along the backing plate connection surface 48′.

1. A wear assembly for a helically formed, metal screw conveyor of a decanter centrifuge, the assembly comprising:
a wear plate defining a wear plate front surface and a wear plate rear surface, the wear plate rear surface defining a wear plate top edge, a wear plate bottom edge and two oppositely located wear plate side edges interconnecting the wear plate top edge and the wear plate bottom edge, the wear plate rear surface further defining a longitudinal direction extending from the bottom edge to the top edge, the wear plate defining wear plate connection surfaces extending substantially in the longitudinal direction on the wear plate rear surface and a wear plate abutment surface extending substantially parallel with the wear plate top edge on the wear plate rear surface, and
a backing plate defining a backing plate front surface and a backing plate rear surface, the backing plate rear surface being attachable to the helically formed, metal screw conveyor, the backing plate defining backing plate connection surfaces on the backing plate front surface for engaging with the wear plate connection surfaces, the backing plate further defining a backing plate abutment surface on the backing plate front surface for contacting the wear plate abutment surface when the backing plate connection surfaces have been engaged with the wear plate connection surfaces.

2. The wear assembly according to claim 1, wherein the backing plate connection surfaces engages with the wear plate connection surfaces by a sliding movement between the wear plate rear surface and the backing plate front surface in the longitudinal direction of the wear plate

3. The wear assembly according to claim 1, wherein the backing plate connection surfaces and the wear plate connection surfaces define a projection and a slot of complementary shape in which the projection engages.

4. The wear assembly according to claim 3, wherein the projection is provided on the wear plate and the slot is formed in the backing plate.

5. The wear assembly according to claim 3, wherein the projection has a dovetail cross-section.

6. The wear assembly according claim 3, wherein the projection and the slot taper in width in the longitudinal direction.

7. The wear assembly according to claim 1, wherein the assembly further comprising a locking plate which, when the wear plate engages the backing plate, is being attachable to the backing plate at the wear plate bottom edge for retaining the wear plate relative to the backing plate in a direction from the wear plate top edge towards the wear plate bottom edge.

8. The wear assembly according to claim 7, wherein the locking plate comprising a protrusion which, when the wear plate engages the backing plate, protrudes into a complementary opening in the wear plate.

9. The wear assembly according to claim 1, wherein a rubber film is provided between the wear plate and the backing plate, the rubber film preferably being applied on the wear plate rear surface and/or the backing plate front surface by spraying.

10. The wear assembly according to claim 1, wherein the backing plate comprises a wear indicator on the rear surface.

11. The wear assembly according claim 1, wherein the top edge is between 10 mm to 100 mm, preferably between 25 mm to 75 mm.

12. The wear assembly according to claim 1, wherein the backing plate being made of a softer material than the wear plate, the wear plate preferably being made of carbide such as tungsten carbide, ceramic, polyuretan or polyurea, and the backing plate preferably being made of steel, such as stainless steel.

13. A helically formed, metal screw conveyor for a decanter centrifuge comprising one or more wear assemblies according to claim 1, wherein the backing plate rear surface being attached to an edge of the helically formed, metal screw conveyor and the longitudinal direction corresponds to a radially outward direction from an axis of the helically formed, metal screw conveyor.

14. The helically formed, metal screw conveyor for a decanter centrifuge according to claim 13, wherein wear assembly is attached to the helically formed, metal screw conveyor by a weld at the edge of the helically formed, metal screw conveyor.

15. A method of installing a wear assembly on a helically formed, metal screw conveyor for a decanter centrifuge, the assembly comprising:
a wear plate defining a wear plate front surface and a wear plate rear surface, the wear plate rear surface defining a wear plate top edge, a wear plate bottom edge and two oppositely located wear plate side edges interconnecting the wear plate top edge and the wear plate bottom edge, the wear plate rear surface further defining a longitudinal direction extending from the bottom edge to the top edge, the wear plate defining wear plate connection surfaces extending substantially in the longitudinal direction on the wear plate rear surface and a wear plate abutment surface extending substantially parallel with the wear plate top edge on the wear plate rear surface, and
a backing plate defining a backing plate front surface and a backing plate rear surface, the backing plate rear surface being attachable to the helically formed, metal screw conveyor, the backing plate defining backing plate connection surfaces on the backing plate front surface, the backing plate further defining a backing plate abutment surface on the backing plate front surface,
the method comprising performing the steps of:
engaging the backing plate connection surfaces with the wear plate connection surfaces, and,
contacting the backing plate abutment surface with the wear plate abutment surface.

16. The wear assembly according to claim 2, wherein the backing plate connection surfaces and the wear plate connection surfaces define a projection and a slot of complementary shape in which the projection engages.

17. The wear assembly according to claim 4, wherein the projection has a dovetail cross-section.

18. The wear assembly according to claim 4, wherein the projection and the slot taper in width in the longitudinal direction.

19. The wear assembly according to claim 5, wherein the projection and the slot taper in width in the longitudinal direction.

20. The wear assembly according to claim 2, wherein the assembly further comprising a locking plate which, when the wear plate engages the backing plate, is being attachable to the backing plate at the wear plate bottom edge for retaining the wear plate relative to the backing plate in a direction from the wear plate top edge towards the wear plate bottom edge.
